(19) United States
(12) Patent Application Publication
(10) Pub. No.: US 2010/0194277 A1
(43) Pub. Date: Aug. 5, 2010

(54) LED Emergency Light Installed in Lamp Receptacle

(76) Inventor: Young Ho Yoo, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/669,921

(22) PCT Filed: Jul. 24, 2008
(86) PCT No.: PCT/KR08/04328

§ 371 Date: Jan. 20, 2010

(30) Foreign Application Priority Data
Jul. 27, 2007 (KR) 10-2007-0075930
Aug. 31, 2007 (KR) 10-2007-0088556

(51) Int. Cl. H05B 37/02

(52) U.S. Cl. 315/86

(57) ABSTRACT

The present invention relates to an LED emergency light installed in a lamp receptacle. The LED emergency light includes a light source unit (30), in which LEDs are mounted on a PCB. In a housing (10), a threaded receptacle coupling unit (11) is provided, and the light source unit is installed. A power connection unit (20) includes switching means (21), connected to the threaded receptacle coupling unit to automatically supply power from a primary cell (40) to the light source unit at a time of a power failure, and ON/OFF control means (25), configured to limit and adjust a time for which current the primary cell flows through the light source unit. The primary cell is electrically connected to the power connection unit and the light source unit, and turns on the LEDs by supplying power to the light source unit at a time of power failure.

### TECHNICAL FIELD

The present invention relates, in general, to an LED emergency light, and, more particularly, to an LED emergency light installed in a lamp receptacle, in which an installation operation, an inspection operation of producing a power failure state, and the replacement and management of a primary cell can be greatly facilitated using a housing coupled to the lamp receptacle, thus not only allowing anyone, including a housewife, to easily install and manage the LED emergency light without difficulties, but also greatly improving the efficiency of the primary cell by causing current to flow through a light source unit only for a preset period of time in the event of a power failure.

### BACKGROUND ART

Emergency lights are installed in various buildings or underground facilities so that persons can take shelter in a safe place when the supply of power is shut off due to natural disasters, such as fires or earthquakes.

Generally, such an emergency light is configured such that a small fluorescent lamp is installed as a light source in a rectangular case, a green floodlight exit sign is coupled to the front of the case, and a charging system for charging power at normal times when AC power is supplied and for supplying DC power at the time of a power failure is electrically connected to a power circuit.

Since the above-described emergency light has an installation structure differing from that of a typical lighting apparatus, and power is related to a central system, a power failure state must be produced without influencing other electric facilities in a building so as to conduct an inspection. As a result, the installation, handling, management, and inspection of the emergency light can be conducted only by technical experts, and expend much manpower and time.

Further, when a storage cell is used, it is expensive and heavy, so that the handling and installation thereof are difficult, and a connection operation is complicated, and thus it is impossible for persons other than an expert to replace an exhausted storage cell.

Meanwhile, recently, natural disasters such as earthquakes have frequently occurred. In particular, in an area located in an earthquake zone, an emergency light is required as essential safety equipment even in a typical home.

However, since the installation and handling of an emergency light are possible only by technical experts, there are many difficulties in the management of an emergency light in such a way that, in typical homes in which a housewife takes charge of the management of an emergency light, high costs are incurred, and, additionally, inconvenience, such as by requesting a visit for installation or handling from a technical expert, is caused.

### DISCLOSURE OF INVENTION

### Technical Problem

Accordingly, the present invention has been made keeping in mind the above problems occurring in the prior art, and an object of the present invention is to provide an LED emergency light installed in a lamp receptacle, in which an installation operation, an inspection operation of producing a power failure state, and the replacement and management of a primary cell can be greatly facilitated using a housing coupled to the lamp receptacle, thus not only allowing anyone, including a housewife, to easily install and manage the LED emergency light without difficulties, but also greatly improving the efficiency of the primary cell by causing current to flow through a light source unit only for a preset period of time in the event of a power failure.

### Technical Solution

In order to accomplish the above object, the present invention provides a Light Emitting Diode (LED) emergency light installed in a lamp receptacle, comprising a light source unit configured such that LEDs are mounted on a Printed Circuit Board (PCB); a housing in which a threaded receptacle coupling unit coupled to the lamp receptacle is provided, and in which the light source unit is installed; a power connection unit including switching means, which is connected to the threaded receptacle coupling unit and is configured to automatically supply power from a primary cell to the light source unit at a time of a power failure, and ON/OFF control means, which is configured to limit and adjust a time for which current from the primary cell flows through the light source unit; and the primary cell electrically connected both to the power connection unit and to the light source unit and configured to turn on the LEDs by supplying power to the light source unit through the switching means and the ON/OFF control means at a time of a power failure.

### ADVANTAGEOUS EFFECTS

An LED emergency light installed in a lamp receptacle according to the present invention having the above construction is advantageous in that an installation operation, an inspection operation of producing a power failure state, and the replacement and management of a primary cell can be greatly facilitated using a housing coupled to the lamp receptacle, thus not only allowing anyone, including a housewife, to easily install and manage the LED emergency light without difficulties, but also greatly improving the efficiency of the primary cell by causing current to flow through a light source unit only for a preset period of time in the event of a power failure.

### BRIEF DESCRIPTION OF THE DRAWINGS

FIG. 1 is an exploded sectional view showing construction according to an embodiment of the present invention;

FIG. 2 is a view showing the assembly of FIG. 1; and

FIG. 3 is a circuit diagram according to an embodiment of the present invention.

### DESCRIPTION OF REFERENCE NUMERALS OF PRINCIPAL ELEMENTS IN THE DRAWINGS

1: LED emergency light installed in lamp receptacle according to the present invention
10: housing 20: power connection unit 21: switching means (relay switch)
25: ON/OFF control means 27: voltage detection means 28: external indication means
30: light source unit 31: LED 33: PCB
40: primary cell 41: cell container 50: heat sink bracket
60: photo-induced diffusion means 62: engaging portion 63: chamber

### BEST MODE FOR CARRYING OUT THE INVENTION

Hereinafter, embodiments of a Light Emitting Diode (LED) emergency light installed in a lamp receptacle according to the present invention will be described in detail with reference to the attached drawings.

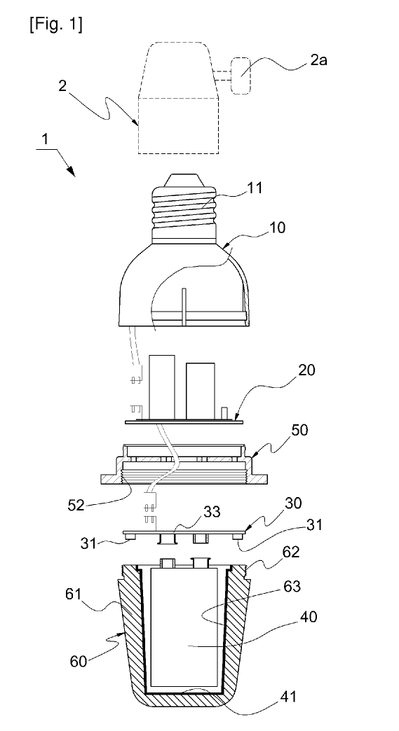

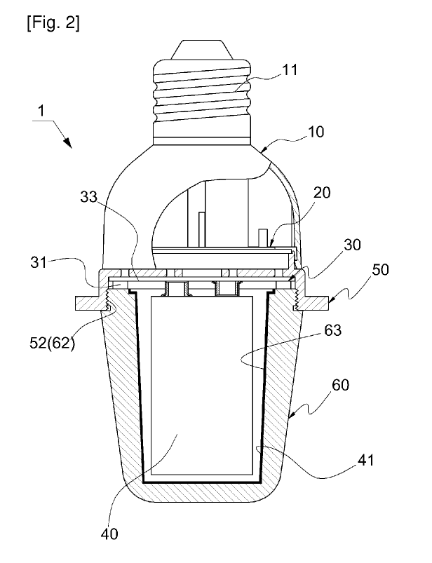

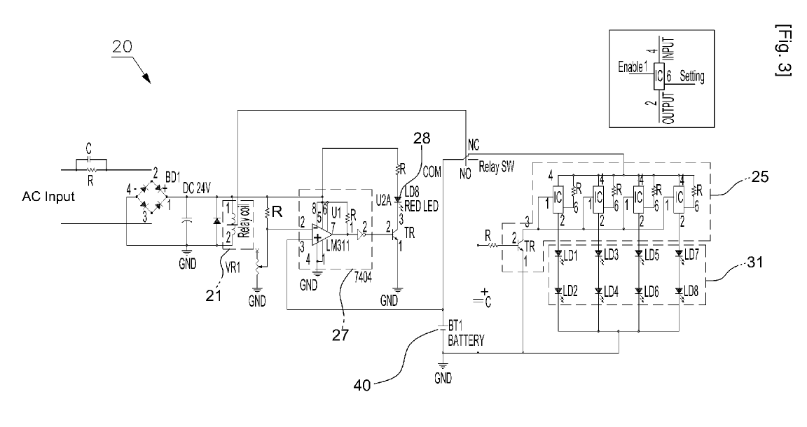

FIG. 1 is an exploded sectional view showing construction according to an embodiment of the present invention, FIG. 2 is a view showing the assembly of FIG. 1, and FIG. 3 is a circuit diagram according to an embodiment of the present invention.

As shown in FIGS. 1 to 3, an LED emergency light 1 installed in a lamp receptacle 2 according to the present invention includes a light source unit 30 configured such that LEDs 31 are mounted on a Printed Circuit Board (PCB) 33, a housing 10 in which a threaded receptacle coupling unit 11 coupled to the lamp receptacle 2 is provided, and in which the light source unit is installed, a power connection unit 20 including a switching means 21, which is connected to the threaded receptacle coupling unit 11 and is configured to automatically supply power from a primary cell to the light source unit 30 at the time of a power failure, and an ON/OFF control means 25, which is configured to limit and adjust the time for which current from the primary cell 40 flows through the light source unit 30, and the primary cell 40 electrically connected both to the power connection unit 20 and to the light source unit 30 and configured to turn on the LEDs 31 by supplying power to the light source unit 30 through the switching means 21 and the ON/OFF control means 25.

Here, the power connection unit 20 preferably includes a primary cell voltage detection means 27 and an external indication means 28, which are configured to detect the voltage of the primary cell 40 decreasing below a preset value and externally indicate the decreasing voltage when the voltage of the primary cell 40 decreases below the preset value.

The voltage detection means 27 is implemented as a voltage detection circuit, and the external indication means 28 is implemented as a green LED, which is turned on when the voltage decreases below the preset value.

Further, the ON/OFF control means 25 is implemented as a well-known timer.

Furthermore, the switching means 21 is preferably implemented as a relay switch for allowing power from the primary cell 40 to be supplied to the light source unit 30 at the time of a power failure.

As shown in FIG. 3, in the electric circuit according to an embodiment of the present invention, the flow of current from the primary cell 40 through the light source unit, and more exactly, the short circuit of the primary cell to the ON/OFF control means, can be realized by the relay switch 21. The electric circuit may implement both the case where AC current is directly connected to the relay switch 21 and the case where the AC current is supplied as a DC current through a transformer provided in the power connection unit. Even when current is supplied as the DC current, the electric circuit can be variously designed.

The LED emergency light 1 may further include a heat sink bracket 50, which supports the power connection unit 20 and the light source unit 30 and is connected to and mounted on the PCB 33.

In addition, the LED emergency light 1 may further include a photo-induced diffusion means 60 installed adjacent to the light source unit 30 and configured to induce and diffuse light emitted from the LEDs 31.

The photo-induced diffusion means 60 is configured such that a chamber 63 for accommodating the primary cell is formed in a body 61, and such that the inner surface of the chamber 63 may be coated with a reflective sheet or reflective material for reflecting light emitted from the LEDs and preventing the primary cell 40 from being externally shown, or, alternatively, a cell container 41 may be installed on the inner surface of the chamber.

Further, respective engaging portions 62 and 52 are preferably formed on the photo-induced diffusion means 60 and the heat sink bracket 50 so that the photo-induced diffusion means 60 can be freely detached from or attached to the heat sink bracket 50.

Each of the engaging portions 62 and 52 can be configured in a threaded manner.

The operating state of the LED emergency light 1 installed in a lamp receptacle according to the present invention will be described below.

In a normal situation in which electricity is being externally supplied, the coil of the relay switch, that is, the switching means 21, functions as a magnet upon supply of external current, and attracts a steel plate. In a power failure situation, that is, when the supply of current to the relay switch coil from the outside is shut off, the relay switch coil loses magnetism and then releases the steel plate, so that the switch unit attached to the steel plate enters an ON state.

Due to the switching of the relay switch, power from the primary cell 40 is supplied to the light source unit 30 through the ON/OFF control means 25 at the time of a power failure, and thus the LEDs 31 of the light source unit are turned on.

Since the relay switch 21 mechanically opens or closes a contact point, a period during which the primary cell is effective is maximized by preventing current from being leaked from the primary cell 40 at normal times.

However, at the time of a power failure, when the ON state of the LEDs 31 is unnecessarily maintained, for example, when a power failure occurs in the state in which an emergency light is not required, as in the case of a power failure accident occurring in the daytime, there is a hazard that the primary cell may be continuously discharged and then exhausted when the LEDs are continuously maintained in the ON state and a manager does not recognize this situation.

The ON/OFF control means 25 is configured to overcome such a hazard.

When the relay switch performs switching due to the occurrence of a power failure, and then the LEDs 31 are turned on, current from the primary cell flows through the light source unit 30 only for the time set by the ON/OFF control means 25, that is, the timer (for example: 10 minutes), and is shut off after the set time has elapsed.

The set time is adjusted in consideration of the time for which persons can take shelter when a power failure, such as in an earthquake or a fire, occurs. A 9V alkaline cell, as the primary cell, can continuously turn on eight LEDs, operating at 3.3V and 55 mA, for 120 minutes. Therefore, when the time set by the ON/OFF control means 25 is 10 minutes, it is estimated that the alkaline cell can be theoretically used for 12 power failure accidents on the same condition.

Meanwhile, the primary cell 40 is completely exhausted due to natural discharging if a predetermined period of time has elapsed. Accordingly, even if a power failure accident does not occur, the primary cell must be replaced when it is exhausted due to the elapsing of its normal effective period, or discharging caused by the occurrence of a power failure. Components for indicating such a suitable replacement time point are the voltage detection means 27 and the external indication means 28.

That is, when the voltage of the primary cell 40 is detected, and decreases below a preset voltage, for example, 7V in the case of a 9V alkaline cell, a red LED, which is the external indication means 28 connected to the circuit, flashes on and off, thus externally indicating the time at which a primary cell must be replaced.

The present invention is implemented using the construction in which the housing 10 is coupled to the lamp receptacle, thus enabling installation in the home to be greatly conveniently performed.

Further, the production of a power failure state for inspection is simply realized merely by manipulating the switch 2a of the lamp receptacle 2 to an OFF state (refer to FIG. 1). The switch 2a may also be installed on the surface of a wall.

Furthermore, the present invention not only can indicate the replacement time of a primary cell in advance, but also can greatly facilitate the operation of replacing the primary cell 40 because the photo-induced diffusion means 60, which accommodates the primary cell, can be freely detached from or detached to the heat sink bracket 50 in a threaded manner or the like.

In this way, the present invention is configured such that the housing 10 is formed to be installed in the lamp receptacle, power from the primary cell is supplied to the light source unit through a switching operation using the relay switch at the time of a power failure, and current flows through the light source unit only for a preset period of time, so that the primary cell is efficiently used, and an installation operation, an inspection operation of producing a power failure state, and the replacement and management of a primary cell can be easily performed, thus allowing a general housewife to easily install, handle and manage the LED emergency light, and enabling the emergency light to be easily installed and managed in normal homes without difficulties.

As described above, the preferred embodiments of the present invention have been described with reference to the attached drawings. The terms and words used in the present specification and claims should not be interpreted as being limited to their typical meaning based on the dictionary definitions thereof, but should be interpreted to have the meaning and concept relevant to the technical spirit of the present invention. Therefore, the embodiments described in the present specification and constructions shown in the drawings are only preferred embodiments of the present invention, and do not represent all technical spirits of the present invention. Accordingly, it should be understood that various equivalents and modifications capable of replacing these embodiments may exist at the time at which the present invention was filed.

### INDUSTRIAL APPLICABILITY

An LED emergency light installed in a lamp receptacle according to the present invention, having the above construction, is advantageous in that an installation operation, an inspection operation of producing a power failure state, and the replacement and management of a primary cell can be greatly facilitated using a housing coupled to the lamp receptacle, thus not only allowing anyone, including a housewife, to easily install and manage the LED emergency light without difficulties, but also greatly improving the efficiency of the primary cell by causing current to flow through a light source unit only for a preset period of time in the event of a power failure.

1. A Light Emitting Diode (LED) emergency light installed in a lamp receptacle, comprising:
a light source unit (30) configured such that LEDs (31) are mounted on a Printed Circuit Board (PCB)(33);
a housing (10) in which a threaded receptacle coupling unit (11) coupled to the lamp receptacle is provided, and in which the light source unit is installed;
a power connection unit (20) including switching means (21), which is connected to the threaded receptacle coupling unit (11) and is configured to automatically supply power from a primary cell (40) to the light source unit (30) at a time of a power failure, and ON/OFF control means (25), which is configured to limit and adjust a time for which current from the primary cell (40) flows through the light source unit (30); and
the primary cell (40) electrically connected both to the power connection unit (20) and to the light source unit (30) and configured to turn on the LEDs (31) by supplying power to the light source unit (30) through the switching means (21) and the ON/OFF control means (25) at a time of a power failure.

2. The LED emergency light according to claim 1, wherein the power connection unit (20) comprises primary cell voltage detection means (27) and external indication means (28) for detecting a voltage of the primary cell (40), decreasing below a preset value, and for externally indicating the detected voltage when the voltage of the primary cell (40) decreases below the preset value.

3. The LED emergency light according to claim 1, wherein the switching means (21) is implemented as a relay switch for supplying power from the primary cell (40) to the light source unit (30) at a time of a power failure.

4. The LED emergency light according to claim 1, further comprising a heat sink bracket (50) configured to support both the power connection unit (20) and the light source unit (30) and connected to and mounted on the PCB (33).

5. The LED emergency light according to claim 1, further comprising photo-induced diffusion means (60) installed adjacent to the light source unit (30) and configured to induce and diffuse light emitted from the LEDs (31).

6. The LED emergency light according to claim 5, wherein the photo-induced diffusion means (60) comprises a chamber (63) formed therein for accommodating the primary cell; and
the chamber (63) is configured such that an inner surface thereof is coated with a reflective sheet or reflective material for reflecting light emitted from the LEDs and preventing the primary cell (40) from being externally shown, or, alternatively, a cell container (41) is installed on the inner surface.
